(19) United States
(12) Patent Application Publication
(10) Pub. No.: US 2016/0259659 A1
(43) Pub. Date: Sep. 8, 2016

(54) Method and system for unified application centric connectivity in various virtualization platforms

(71) Applicant: Cheng Tang, Saratoga, CA (US)

(72) Inventor: Cheng Tang, Saratoga, CA (US)

(73) Assignee: FlyCloud Systems, Inc, San Jose, CA (US)

(21) Appl. No.: 14/641,163

(22) Filed: Mar. 6, 2015

(51) Int. Cl. G06F 9/455; H04L 12/24

(52) U.S. Cl. CPC G06F 9/45558; H04L 41/0816; G06F 2009/45595

(57) ABSTRACT

A method and system implementing application centric connectivity under various virtualization platforms are disclosed. According to one embodiment, a system comprises a virtual platform running on a physical machine; a virtual machine that hosts an application running on the virtual platform; a device binding module running on the virtual platform; a virtual device module running inside a virtual machine, a centralized management module running on datacenter management network. The binding module connects a virtual function of physical hardware interface card to the virtual machine and instructs the virtual device module to instantiate a virtual network device and a virtual storage device inside the virtual machine. The device binding module is in communication with the management module and receives updates from the management module and applies them to the virtual device in real time through the virtual device module. The management module ensures the consistent connectivity for an application in various virtualization platforms.

### FIELD

The present system and method relate to application centric connectivity management, and more particularly, to implementing application centric connectivity that works consistently in various virtualization platforms.

### BACKGROUND

Server virtualization refers to implementing a machine using software. A software-implemented machine is generally known as a virtual machine (VM). The software layer providing the virtualization is known as a hypervisor. The hypervisor provides virtual hardware components to multiple virtual machines that run simultaneously on one physical machine. Application running on a virtual machine accesses the physical input/out (I/O) devices through virtual network interface card (vNIC) and SCSI HBA emulation provided by the hypervisor.

A VM's vNIC gets a MAC address assigned by hypervisor so it may change when the VM is moved to another hypervisor. The vNIC connects to a software virtual switch that has at least one physical NIC port as uplink. The hypervisor is involved in copying packets from physical NIC to a virtual machine on receiving side. On transmitting side, hypervisor copies a packet from virtual machine to the physical NIC. This introduces significant network latency to application and creates CPU overhead on the physical machine. In a typical configuration, the multiple virtual machines share a single virtual switch. The application network policies such as high availability (HA) failover policy is configured on virtual switch so multiple virtual machines must share the same policy. A network HA is a feature that multiple uplinks are bonded together at virtual switch. When a link failure occurs, the bond virtual switch moves the traffic to the remaining link, seamlessly providing the network connectivity. There are multiple HA setting options, for instance, active-active and active-standby. The path selection can use source MAC address or IP address or port number or combination of those. When a VM is moved to another hypervisor, the proper policy setting also needs to be moved as well, introducing operational overhead, and is difficult to maintain consistent policy settings across hypervisors.

Similar issues exist on the storage side and the storage policy is more complicated as it depends on characteristics of a storage array and often requires the specific storage plug in software to be integrated with the hypervisor. Furthermore, as all VM's storage traffic go through hypervisor that controls the physical host bus adaptor on the physical machine, the VM's native storage identity such as worldwide port name (WWPN) is not present in data traffic on the storage fabric. Storage vendors will have to rely on integration with virtual platform to implement VM specific storage tasks such as data copy.

Beside the CPU overhead and latency, the hypervisor centric connectivity solution also creates operation challenges for enterprise mission critical applications because they demand low network latency but also the capability to leverage existing storage infrastructure shared by physical platforms. It becomes common that multiple virtual platforms (e.g., ESX, KVM, CitrixXen Server, and Hyper-V) exist in enterprise data centers. Enterprises want the ability to migrate virtual machines across those virtual platforms to avoid vendor lock in. Hypervisor centric networking and storage makes such migration difficult as each implements its own data format and tooling preventing enterprise customers from deploying applications across various virtualization platforms to leverage the advancement of virtualization technology to reduce operational cost.

In view of the foregoing, there exists a need for a method and system for implementing unified application centric connectivity under machine virtualization that allows customers to seamlessly deploy applications across heterogeneous virtualization platforms.

### SUMMARY

A method and system implementing unified application centric connectivity under various virtualization platforms are disclosed. According to one embodiment, a system comprises a virtual platform running on a physical machine; a virtual machine that hosts an application running on the virtual platform; a device binding module running on the virtual platform; a virtual device module running inside a virtual machine, a centralized management module running on datacenter management network. The binding module connects a virtual function of physical hardware interface card to the virtual machine and instructs the virtual device module to instantiate a virtual network device and a virtual storage device inside the virtual machine. The device binding module is in communication with the management module and ensures that the virtual devices are private to the application. The device binding module receives updates from the management module and applies them to the virtual device in real time through the virtual device module. The management module ensures the consistent connectivity for an application in various virtualization platforms.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates a system architecture in the prior art in which multiple applications run in a hypervisor on a single physical machine that share the same network and storage policy configured inside hypervisor kernel.

FIG. 2 illustrates an exemplary server architecture for ensuring that a hypervisor (110) independent application connectivity is being run on each virtual machine, according to one embodiment

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

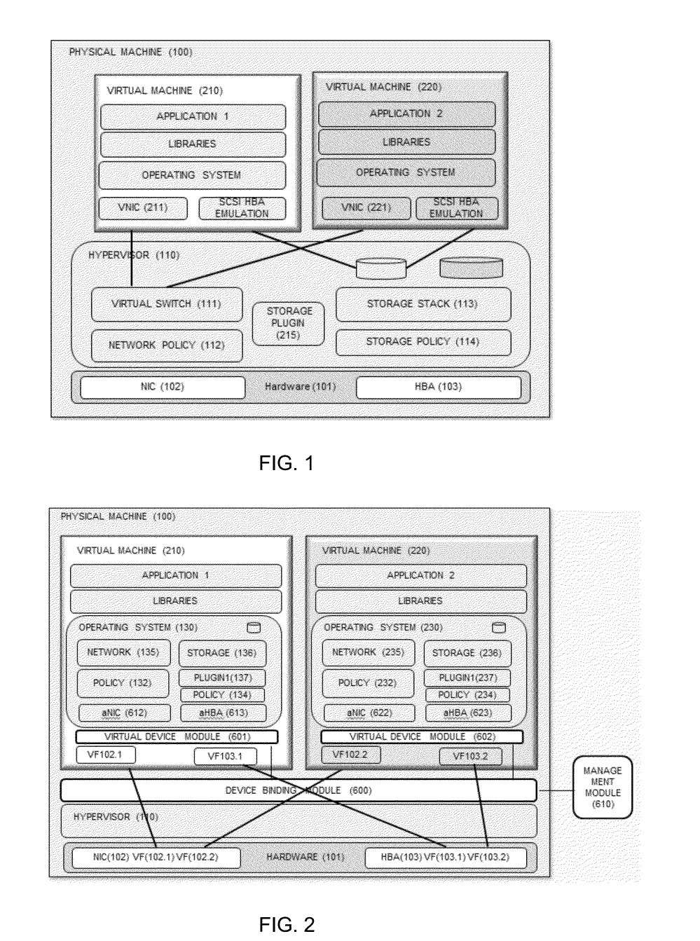

FIG. 1 illustrates a virtualization platform in the prior art in which multiple applications (each runs in side a virtual machine) may be run on a hypervisor platform. As FIG. 1 illustrates, a physical machine 100 has a VM hypervisor 110 implemented on physical hardware 101. Physical machine 100 may be a general purpose computer. Physical hardware 101 may include the typical hardware components of a general purpose computer, such as a computer processor, a memory module, a hard disk, a network interface card NIC (102), and a storage host bus adaptor HBA (103). The VM hypervisor 110 allows virtual machine 210 that hosts the application 1 and virtual machine 220 that hosts the application 2 to run simultaneously and separately from each other. The vNIC (211) on virtual machine 210 and the vNIC (221) on virtual machine 220 share the virtual switch (111) hence the associated network policy (112). This will work only when both applications have the same policy.

When the virtual machine 210 moves to another hypervisor, it must connect to a virtual switch that satisfies its network requirement. Further, the MAC address of the vNIC (211) is seen on external network fabric and may be used as a key to implement VM based fabric Qos policy. Once the virtual machine is moved to another hypervisor, its vNIC MAC address may change, breaking its fabric Qos policy unless all switch nodes implement the Qos policy are updated with the new MAC address which is a difficult task in multi hypervisor environment.

On storage side, the hypervisor storage stack (113) places two virtual machines (210 and 220) on the same LUN (logical unit number, i.e., disk) and accepts storage commands from both virtual machines (210 and 220), puts them into different queues, and completes them on behalf of virtual machines through a host bus adaptor (103) that connects to storage fabric. Both virtual machines share the same WWPN on the single physical HBA port (103). Hence it is difficult to implement application aware storage policy, both at storage array and in storage fabric. The virtual platform such as ESX allows a virtual machine to have its own WWPN only for raw disk mapping. However, the WWPN may change when the virtual machine is moved to another hypervisor. Furthermore, the storage array-specific operations are accomplished by integrating storage vendor's plugin modules 215 at hypervisor level which requires a system reboot. Hypervisors like ESX and Hyper-V are proprietary so storage integration requires collaborative effort among hypervisor and storage vendors. This makes difficult for applications running on the virtualization platform to leverage the innovations in storage array.

ARCHITECTURE

FIG. 2 illustrates an exemplary system architecture in which unified application centric connectivity is implemented in a hypervisor platform, according to one embodiment. As FIG. 2 illustrates, a VM hypervisor 110 is implemented on physical hardware 101. The VM hypervisor 110 allows virtual machines 210 and 220 to run simultaneously and separately from each other. The device binding module 600 is run on the physical machine 100. When the virtual machine (210) is launched on the physical machine 100, the device binding module (600) projects a virtual function (VF102.1) on the hardware network NIC 102 and a virtual function (VF103.1) on the hardware HBA 103 to virtual machine 121. A virtual function allows a virtual machine to access hardware resource directly to send or receive packet to or from external network. This eliminates the hypervisor overhead and reduces the CPU utilization because the hardware moves packets to or from virtual machine, resulting in low latency.

The virtual device module 601 running on the virtual machine 210 maintains an internal communication (such as a TCP connection to a known port) with the device binding module 600 to obtain the application specific connectivity information received from the management module 610. Such information instructs the virtual device module (601) to create an application specific aNIC 612 on top of the VF102.1 with specified MAC address and other properties such as virtual LAN (vlan) and maximum transmit unit. All packets sent out the aNIC 612 will have the unique MAC address (612) as source MAC that can be used to implement application aware network policy, such as MAC based vlan or Qos policy. An application specific block storage interface aHBA 613 is also created by the virtual device module (601) with unique worldwide port name (WWPN) that is mapped to N_port ID of the VF103.1. This WWPN is used for storage area network (SAN) zoning and LUN presentation which simplifies the implementation of application aware storage policy in SAN or at storage devices.

Both aNIC (612) and aHBA (613) are presented to the operating system 130 of virtual machine 210 and application specific network policy (132) and storage policy (134) are implemented inside the operating system such as Linux. Storage plugin (137) integration is also occurring inside the operating system of the application and does not affect functionality of other virtual machine (220). As a result, when the virtual machine 121 is moved to run on another hypervisor platform, it will see the same connectivity (aNIC 612 and aHBA 613) hence the operator does not have to worry about the misalignment of underlying hypervisor settings and application requirements.

Furthermore, application 1 running on virtual machine 210 can have its private and customized network stack (135) and storage stack (136) to meet its own requirements. The MAC address of a aNIC and the WWPN of a aHBA are centrally managed and bound to a virtual machine based on its name or universal unique identifier. This application specific binding remains same during migration of the virtual machine across multiple types of hypervisors. All network and storage policy for the virtual machine remain functional when the virtual machines moves from one virtual platform to another.

For application 2 hosted by virtual machine 220, it also gets its own aNIC 622 and aHBA 623 inside operating system 230 such as Microsoft Windows. Both network stack 235 and storage stack 236 can be customized and network policy 232, storage policy 234, and needed plug in 237 can also be configured to meet requirement of application 2. The applications see consistent and predictable network and storage connectivity that is independent of underlying hypervisor and hardware.

It is recognized that the hypervisor tooling may not be available for a virtual machine once it uses the unified application centric network and storage connectivity aforementioned. Certain features such as snapshot and live virtual machine move (vMotion) are not available. Furthermore, the control plan management (plugins) integration with the hypervisor's management system is needed to provide visibility and monitoring of the application centric devices.

It is noted that hypervisor tooling is vendor specific and in a heterogeneous virtual platform environment, the common tooling most likely come with storage and networking equipment. The application centric connectivity model allows a virtual machine to interact with those common tooling directly, bypassing hypervisor to enable easy migration across multiple virtual platforms.

Usage Model

Enterprises are in the process to migrate mission critical applications to cloud for agility and efficiency. As OpenStack becomes mature and reliable, it has been quickly adopted by enterprises to stand up private cloud in on premise datacenters. Most mission critical applications are still running on physical platform and heavily reply on the SAN storage for the reason of compliance and performance. Tools that convert physical platform image to virtual machine image ease the migration of compute from physical to virtual (p2v). Further, most customers still want to leverage existing network and storage infrastructure and manage both network and storage of virtual platform the same way in the physical platform.

The architecture of application centric connectivity eases the p2v migration. First, by eliminating the hypervisor overhead, it meets performance requirement of the applications running in virtual platform. Second, the unified application connectivity can be instantiated and tested on physical platform, including network policy, storage policy, both inside the operating system and in data fabric using the persistent MAC address and WWPN. Specific storage plug in can also be validated. Then, just convert the entire physical image into a virtual machine in the format consumable by the target hypervisor. When the virtual machine is launched, it will see the same connectivity which guarantees the predicable performance as all fabric policy implemented for this application remain intact and effective.

To reduce operation expenditure, enterprise customers leverage multiple hypervisor vendors to minimum the licensing cost. This creates a demand of migrating virtualized applications from one virtual platform (hypervisor) to another (v2v). The application centric connectivity architecture makes the v2v migration easy. Just convert the virtual machine image to the target hypervisor format and launch it. After the migration, the application 1 will experience the same IO performance.

We claim:

1. A system for managing unified application centric connectivity under various virtualization platforms, the system comprising: a processor of a physical machine, wherein the processor executes instructions stored in memory and wherein execution of:
a device binding module running on a virtual platform connects a virtual function of hardware interface card to a virtual machine and obtains virtual device configuration for the virtual machine from the management module, and a virtual device module installed on the virtual machine, the virtual device module executed to: maintain live contact with the device binding module, receive instruction from the device binding module, wherein the instruction specifies the number of virtual devices and configuration parameters of each virtual device, create the virtual devices, apply the configuration parameters to each device, and configure the virtual function of the physical interface card to ensure traffic isolation from other virtual machines.

2. The system of claim 1, wherein the specified number of device binding module is one per virtual platform.

3. The system of claim 1, wherein the specified number of virtual device module is one per virtual machine.

4. The system of claim 1, wherein the device binding module automatically connects a virtual function to a virtual machine.

5. The system of claim 1, wherein the communication between the device binding module and the management module allows for the automatic configuration of parameters of the virtual function for the virtual machine.

6. The system of claim 3, wherein the virtual device module instantiates virtual network and storage devices inside the virtual machine's operating system and applies configurations to those devices in real time.

7. The system of claim 3, wherein the virtual device module reports virtual device status and traffic statistics to management module.

8. A method for managing unified application centric connectivity under various virtualization platforms, the method comprising: executing instructions stored in memory of a physical machine, wherein a processor of the physical machine executes:
a device binding module on a virtual platform, the device binding module being executed to automatically connect a virtual function of hardware interface card to a virtual machine, query the management module for virtual device configuration for the virtual machine by using its name or universal unique identifier (UUID), and pass the configuration to the virtual device module, the virtual device module being executed to:
maintain live communication with the device binding module, receive instruction from the device binding module, wherein the instruction specifies the number of virtual devices and configuration parameters of each virtual device, create the virtual devices, apply the configuration parameters to each device, and configure the virtual function of the physical interface card to ensure traffic isolation from other virtual machines.

9. The method of claim 8, wherein the specified number of device binding module is one per virtual platform.

10. The method of claim 8, wherein the specified number of virtual device module is one per virtual machine.

11. The method of claim 8, wherein the device binding module automatically connects a virtual function to a virtual machine through application programming interface provided by the physical function.

12. The system of claim 8, wherein the communication between the device binding module and the management module allows for the automatic configuration of parameters of the virtual function for the virtual machine identified by its name or universal unique identifier (UUID).

13. The method of claim 8, wherein the virtual device module instantiates virtual network and storage devices inside the virtual machine's operating system and applies configurations to those devices in real time.

14. The method of claim 8, wherein the virtual device module reports virtual device status and traffic statistics to management module through the device binding module.

15. A non-transitory computer-readable storage medium, having embodied thereon a program executable by a processor to perform a method for managing unified application centric connectivity, the method comprising: executing a device binding module on a virtual platform, the device binding module being executed to automatically connect a virtual function of hardware interface card to a virtual machine, query the management module for virtual device configuration for the virtual machine by using its name or universal unique identifier (UUID), and pass the configuration to the virtual device module; executing a virtual device module installed on the virtual machine, the virtual device module being executed to: maintain live communication with the device binding module, receive instruction from the device binding module, wherein the instruction specifies the number of virtual devices and configuration parameters of each virtual device, create the virtual devices, apply the configuration parameters to each device, and configure the virtual function of the physical interface card to ensure traffic isolation from other virtual machines.
